(19) United States
(12) Patent Application Publication
(10) Pub. No.: US 2020/0240350 A1
(43) Pub. Date: Jul. 30, 2020

(54) INTERNAL COMBUSTION ENGINE AND METHOD FOR ITS OPERATION

(71) Applicant: PRUEFREX engineering e motion gmbH & co. kg, Cadolzburg (DE)

(72) Inventors: Marius ALBERT, Fuerth (DE); Marek LAJDA, Fuerth (DE)

(73) Assignee: PRUEFREX engineering e motion gmbH & co. kg, Cadolzburg (DE)

(21) Appl. No.: 16/777,356

(22) Filed: Jan. 30, 2020

(30) Foreign Application Priority Data
Jan. 30, 2019 (DE) 10 2019 201 200.0

(51) Int. Cl. F02D 41/30; F02D 41/40

(52) U.S. Cl. CPC F02D 41/3094; F02B 23/101; F02D 41/40

(57) ABSTRACT

A method for operating an internal combustion engine having at least two cylinders and having a single injector for central point injection of fuel into an air intake connected to the cylinders, wherein for each of the cylinders an injection quantity of the fuel and a starting time of the injection are specified and set as a function of the present engine load and the present engine speed. The invention further relates to such an internal combustion engine.

This nonprovisional application claims priority under 35 U.S.C. § 119(a) to German Patent Application No. 10 2019 201 200.0, which was filed in Germany on Jan. 30, 2019, and which is herein incorporated by reference.

### BACKGROUND OF THE INVENTION

### Field of the Invention

The present invention relates to a method for operating an internal combustion engine having at least two cylinders and having a single injector for central point injection of fuel into an air intake connected to the cylinders. Furthermore, the invention relates to such an internal combustion engine.

### Description of the Background Art

For example, an internal combustion engine, in particular an internal combustion engine formed as a small engine, such as an internal combustion engine of a lawnmower or an electric generator, has a central point injection. This is also known as a single point injection. Furthermore, a small engine is understood to be a four-stroke engine with at least two cylinders and a cubic capacity of up to 1000 cm³.

When the internal engine is operating, the fuel is injected by means of an injector into an air intake which is connected to the cylinders of the internal combustion engine in terms of flow technology. In addition, the fuel for the cylinders is injected sequentially. For example, in a combustion engine with two cylinders, two injections are performed per cycle.

In this context, a comparatively long path from the injection site to the air intake to the respective cylinder, (pressure) pulsation of the intake air in the air intake, and/or the construction of the internal combustion engine, in particular a cylinder arrangement corresponding to a so-called bank angle in a V-type construction of the internal combustion engine, can result in uneven distribution of the fuel injected into the air intake to the cylinders, i.e., the cylinders are not supplied the same amount of fuel. For example, a comparatively large amount of fuel is supplied to one of the cylinders and a comparatively small amount to the other cylinder. As a result, the air-fuel ratio is correspondingly rich or correspondingly lean, which in turn can result in poor and uneven engine operation, higher fuel consumption, and/or comparatively low engine output. Furthermore, such an uneven supply of fuel to the cylinders can lead to non-compliance with standards of exhaust gas legislation. For example, if the air-fuel ratio is too lean, the legal exhaust gas temperature specification is exceeded.

### SUMMARY OF THE INVENTION

It is therefore an object of the present invention to provide a particularly suitable method for operating an internal combustion engine, and an internal combustion engine. In particular, the fuel supply to its cylinders should be as uniform as possible.

The method is used for the operation of an internal combustion engine, which is formed in particular as a small engine, which can have at least two cylinders and a single injector. The injector is set up for the central injection (single point injection) of fuel into an air intake connected to the cylinders. The air intake is also referred to as an intake manifold and the injection is accordingly referred to as an intake manifold fuel injection.

In the method, an injection quantity of the fuel and a starting time of the injection as a function of the present engine load and the present engine speed are specified for each of the cylinders and set accordingly. Suitably, the injections following this setting are usually carried out with the preset injection quantity and the preset starting time. The starting time corresponds to a first (angular) position of a crankshaft of the internal combustion engine, in particular in terms of a working cycle. For example, a position and/or rotational speed sensor is used to assign the starting time to the position of the crankshaft. Consequently, it is possible for the injection to be set and/or carried out based on a crankshaft position.

For example, characteristics or tables which are stored in a control unit of the internal combustion engine are used to determine the injection quantity and the starting time of the injection as a function of the present engine load and the present engine speed.

As compared to an operation of the internal combustion engine in which the injections for the respective cylinders occur at mutually uniform intervals and with the same injection quantity regardless of the present engine load and/or the present engine speed, in the inventive method, the injection quantity for one of the cylinders (first cylinder) can be set and, if necessary, is set, to be different from the injection quantity for the other (second) cylinder. Furthermore, the time interval between the injection for the first cylinder and the injection for the second cylinder can be set and is set, if necessary, to be different from the time interval between the injection for the second cylinder and the subsequent injection for the first cylinder.

By means of the method, the effects of the length of the air intake and/or the pressure pulsation of the air in the air intake mentioned above can be compensated for, and are compensated for, in a particularly advantageous manner. Thus, in particular both an adjustable amount of fuel can be supplied to the cylinders, as well as the fuel injected into the intake manifold to the cylinders being uniformly distributed. In summary, a cylinder-selective injection of the fuel into the air intake is carried out with a respective injection quantity and with a respective starting time.

The amount of fuel taken up in the cylinder is particularly dependent on whether the fuel injected into the air intake is fully or only partially absorbed in the course of the air intake phase of the respective cylinder. For example, in the event of a comparatively late injection with respect to an intake phase of the cylinder, not the entire amount of fuel injected into the intake manifold is taken up in said cylinder, but rather a part of the fuel initially remains in the intake manifold and is only taken up during the intake process of the following intake cylinder by the latter. The amount of fuel supplied to the cylinders is therefore particularly dependent on an end time of the injections. According to a suitable design of the method, a suitable end time of the injection, which corresponds to a second (angular) position of the crankshaft of the internal combustion engine, is therefore specified. The starting time of the injection is specified by means of the specified injection quantity. In particular, a connection between injection duration and injection quantity is used for this purpose, which relationship is stored in the control unit, for example, in the form of a characteristic curve or as a parameter of the injector. In summary, the starting time of the injection is specified on the basis of the end time of the injection by means of the fuel injection duration (injection period) corresponding to the injection quantity. For example, the first angular position is also specified by means of the engine speed, the injection duration and the second angular position, and said first angular position is used to control the injector.

For example, the injector is designed as a solenoid valve, to which a separate fuel pump is connected. According to an advantageous embodiment, however, the injector is a so-called unit injector (unit injector system). With such an injector, a separate fuel pump is advantageously not necessary. In addition, such an injector is comparatively cost-saving. Such a unit injector has a coil which, when energized, causes an electromagnetic force on a plunger and moves this to an injection nozzle of the injector. With this (stroke) movement, the fuel is delivered through the injection nozzle into the air intake.

In this case, the starting time of the injection, the end time of the injection and/or the injection quantity of the injection are set on the basis of a temporal current profile of the injector coil. Thus, based on the energization duration of the coil and/or a current strength of the current supply, the respective stroke movement and the corresponding injection amount can be and are specified. The end time of the injection and the starting time of the injection are set accordingly on whether the energization of the coil has ended or started.

The injector also has a spring element by means of which the plunger is reset to a starting position after its stroke movement towards the injection nozzle. The period of time, which is required to move the plunger to the starting position after the stroke movement has ended, is referred to here and below as the plunger return time. The plunger return time is expediently stored in the control unit.

According to a suitable embodiment, the starting time of the injection, the end time of the injection and/or the injection quantity is set as a function of a plunger return time of the plunger. The plunger is preferably returned to its starting position, i.e., the starting point is set such that the plunger is returned to its starting position after the preceding stroke movement, i.e. the spring element is maximally extended. According to this preferred embodiment, the earliest possible starting time after the end of the previous injection process is thus specified by means of the plunger return time. In accordance with this earliest possible starting time of the injection, an injection quantity and/or the end time of the injection are set as appropriate. In this way, a comparatively large amount of fuel can be fed into the air intake by means of the stroke movement. If, on the other hand, the plunger is caused to perform a stroke movement before the end of the plunger return period, i.e. before it reaches its starting position, the amount of fuel delivered to the air intake is reduced accordingly.

After the coil has been energized, it induces a current. The magnetic field generated by this current causes a force which is counter to a restoring force of the spring element, so that the resetting of the plunger to the starting position takes place comparatively slowly. According to an expedient embodiment, the slope of the current profile of the current induced by means of the coil is increased. This way, the current strength of the induced current drops (decays) faster and the plunger return time is reduced. The reduction in the plunger return time advantageously makes it possible for the starting time of the injection to be, or to be able to be selected or specified, closer in time to the end time of the preceding injection.

For example, also, when the engine is cold started or when the engine load rises in a speed range in which due to the injection duration several injections can be carried out for each cylinder per working cycle, several injections are carried out. In particular, multiple strokes of the plunger are carried out to provide a comparatively large amount of fuel for the respective starting phase of the cylinder.

According to an exemplary embodiment, an internal combustion engine can have at least two cylinders, a single injector for central point injection of fuel into an air intake connected to the cylinders and a control unit for performing the method in one of the variants set out above. In particular, the injector is controlled in such a way that for each cylinder, an injection of fuel is carried out in accordance with the injection quantity specified and set as a function of the present engine load and the present engine speed, and in accordance with the starting time of the injection specified and set as a function of the present engine load and the present engine speed.

The injector can be designed as the unit injector described above. In summary, the injector can comprise the coil for moving the plunger, wherein the fuel is fed into the air intake by means of a stroke movement of the plunger towards an injection nozzle caused by the energization of the coil.

The internal combustion engine can have a circuit which is connected in parallel with the injector, which, as described above, serves to increase the slope of the current profile of the current induced by means of the coil following the end of the energization thereof, and to limit the voltage at a control unit connection of the injector.

Such a circuit for limiting the voltage at the control unit connection is also referred to as a clamping network or clipping network.

A control unit connection of the injector is expediently connected in series with the coil. Due to the circuit connected in parallel with the injector, the maximum amount of the voltage induced by the coil is reduced. The control unit connection and, if applicable, a switch of the control unit connected to the former, are thus protected against overvoltage caused by the induction. In particular, a breakdown circuit of the control device switch, that is, of its current-conducting switching due to the induction voltage, is thus avoided.

The circuit can have both a freewheeling diode and a Zener diode connected thereto in series and in the opposite direction for dissipating the energy stored in the coil after ending energization of the coil. As an alternative to the Zener diode, the circuit has a semiconductor switch connected in series with the freewheeling diode, which in particular is designed as a power MOSFET. To dissipate the energy stored in the coil and thus to increase the slope of the induced current, that is to say for a faster decay of the induced current, the Zener diode or the semiconductor switch is preferably operated in the so-called (avalanche breakdown mode) avalanche mode.

If the circuit for limiting the voltage at the control unit connection is not present, essentially all of the energy stored in the coil would be released as heat in the described breakdown circuit of the control unit switch. A thermal load on this switch is consequently comparatively high, in particular when the ambient temperature is comparatively high due to engine operation. When using the circuit for limiting the voltage at the control unit connection, however, the dissipation at least partially takes place in the semiconductor switch or in the Zener diode. As a result, heat is released locally separated from the switch of the control unit. A thermal load on the switch of the control unit is thus reduced.

The internal combustion engine can include the sensor connected to the control unit for determining the (angular) position of the crankshaft and/or an engine speed on the basis of a magnet wheel coupled to the crankshaft. The sensor is designed in particular as a Hall sensor or a VR sensor (variable reluctance sensor). When the crankshaft and the magnet wheel coupled thereto rotate, a voltage is induced which is detected by the sensor. For example, the time profile of the induced voltage for determining the crankshaft position and/or the engine speed is made available to the control unit for evaluation.

For example, the internal combustion engine additionally has a further sensor for determining the pressure and/or the temperature in the air intake. This sensor is expediently connected to the control unit, so that the control unit can determine the engine load on the basis of the values specified and provided by the sensor. For example, for determining the engine load, the control unit is additionally provided with a value which represents a gas pedal position of a device comprising the internal combustion engine and/or a value which represents a position of a throttle valve.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of an internal combustion engine, having two cylinders, an air intake connected to the cylinders and a single injector for the central point injection of fuel into the air intake;

FIG. 2 is a schematic longitudinal section of the injector designed as a unit injector, having a coil for moving a plunger, wherein at a stroke movement of the plunger towards an injection nozzle, fuel is fed into the air intake;

FIGS. 3a and 3b illustrate, in each case, a circuit connected in parallel with the unit injector, having a freewheeling diode and having a semiconductor switch or a Zener diode to increase the slope of a current induced by the coil, which is produced after the end of the energization, causing the stroke movement;

FIG. 4a illustrates a time profile of the current through the coil, wherein the starting times and the end times of the injection are set as a function of the present engine load and the present engine speed, and a stroke position of the plunger corresponding thereto;

FIG. 4b illustrates a time profile of the pressure in the air intake; and

FIG. 5 illustrates an energization duration-injection quantity diagram for a unit injector.

### DETAILED DESCRIPTION

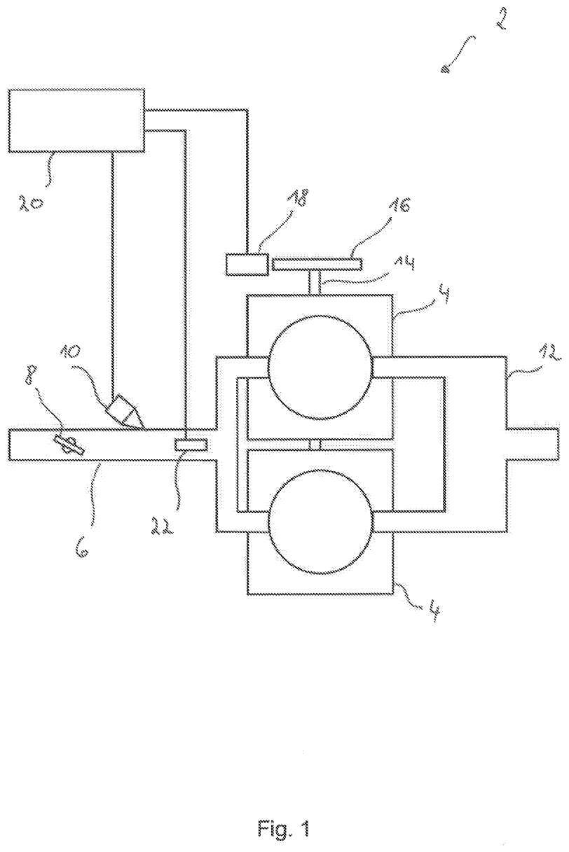

FIG. 1 shows a four-stroke internal combustion engine 2. This has two cylinders 4, which are connected in terms of flow technology for supplying fuel to an air intake 6 also referred to as an intake manifold. In the air intake 6, a throttle valve 8 is arranged, by means of which the amount of air supplied to the cylinders is set during operation. Furthermore, the internal combustion engine 2 has a single injector 10, which is designed as a unit injector and which injects the fuel into the air intake 6 at a single (injection) location. This is also known as central point injection.

Furthermore, the internal combustion engine 2 has an exhaust system 12, which serves to discharge the fuel-air mixture ignited in the cylinders 4.

Further, a crankshaft 14 of the internal combustion engine 2 is coupled with a magnet wheel 16, wherein the magnet wheel 16 rotates in tandem with the crankshaft 14. In this way, an (angular) position of the crankshaft 14 and/or an engine speed can be specified by means of the magnet wheel 16 and by means of a first sensor 18 designed as a so-called VR sensor.

The internal combustion engine 2 also has an (engine) control unit 20, which is connected both to the first sensor 18 designed as a VR sensor and to the injector 10. The control unit 20 is connected to a second sensor 22, which is arranged in the air intake 6 and is also referred to as a TMAP sensor, and which detects the pressure and the temperature in the air intake 6 and makes these available as measured values for the control unit 20. By means of the measured values, the control unit 20 determines the present engine load.

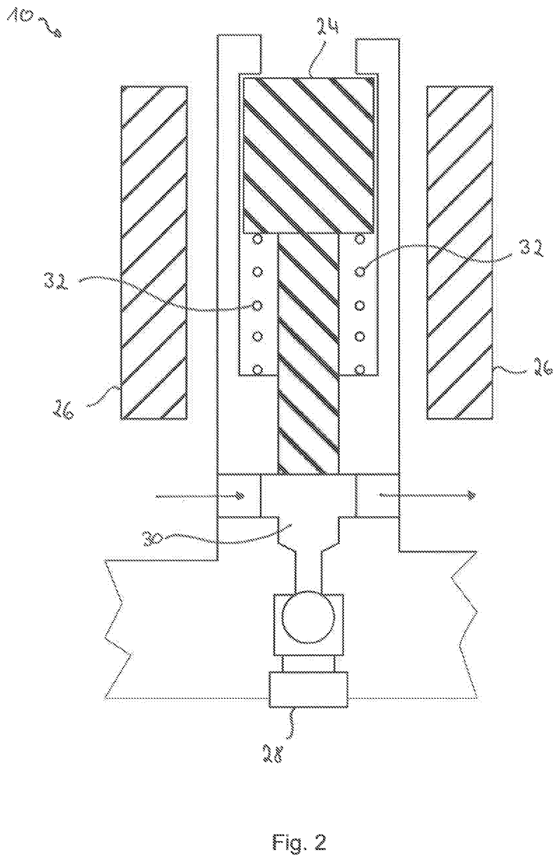

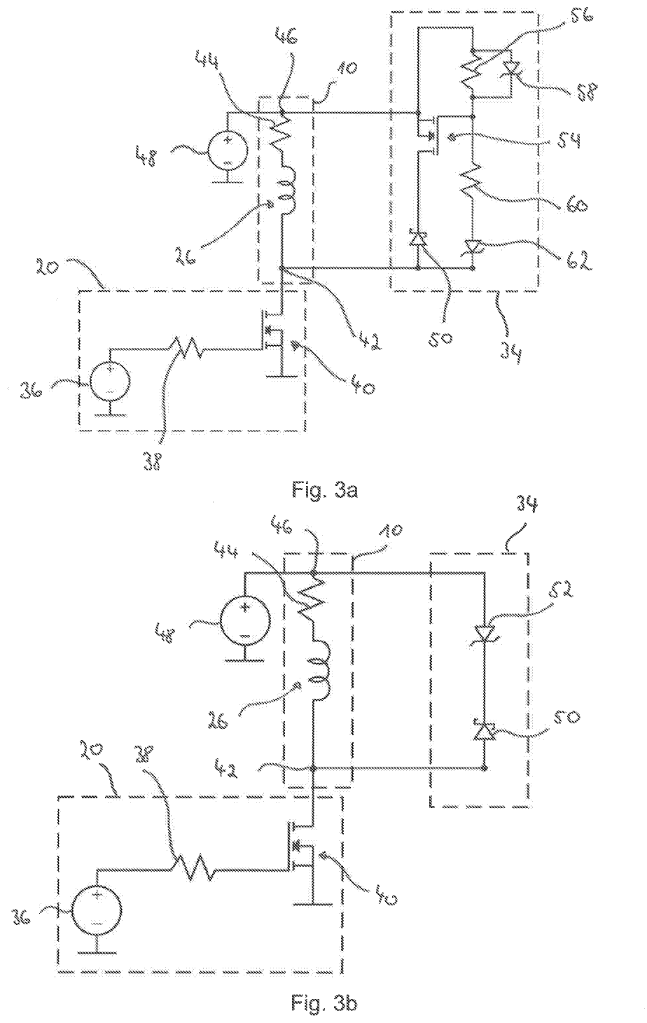

FIG. 2 shows the injector 10 which is designed as a unit injector. This has a plunger 24 and a (solenoid) coil 26. When the coil 26 is energized, the plunger 24 is caused to perform a stroke movement toward an injection nozzle 28. Due to the stroke movement, the fuel received in a fuel chamber 30 arranged between the plunger 24 and the injection nozzle 28 is injected by the injection nozzle 28 into the air intake 6. The fuel feed or the fuel return into or out of the fuel chamber 30 is represented by corresponding arrows. In addition, the injector 10 has a spring element 32, which moves the plunger 24 back to a starting position after the coil 26 has been de-energized, that is to say after the end of the stroke movement. In this case, a current Iₛ is induced by the coil 26 after de-energization. Because of this, a magnetic force is generated which counteracts the restoring effect of the spring element 32. Consequently, the period of time referred to as the return time d_{R}, which the plunger 24 requires to return to its starting position after the stroke movement has ended, is extended accordingly. To allow for the current Iₛ induced in the coil 26 to decay as rapidly as possible, in other words, to increase the slope of the current profile Iₛ(t) of the current Iₛ induced by means of the coil after the end of the movement, a circuit 34 is connected in parallel with the injector 10, which is shown in FIG. 3a or in an alternative embodiment shown in FIG. 3b.

FIGS. 3a and 3b show the control device 20 in sections, wherein it has a voltage source 36, which is connected via a first resistor 38 to a control input designed as a gate of a switch 40 designed as a MOSFET (metal oxide semiconductor field effect transistor).

The injector 10 has a control unit connection 42, by means of which the injector is connected to the control unit 20, in particular on the drain side to the switch 40 of the control unit 20. In addition to the coil 26, the injector 10 has a second resistor 44 connected in series with said coil and a supply input 46 for a further voltage source 48 designed as a battery.

The circuit 34 connected in parallel with the injector 10 according to FIGS. 3a and 3b has a freewheeling diode 50 which prevents a current flow from the voltage source 48 constructed as a battery through the circuit 34 connected in parallel with the injector 10 toward the control device 20, but is switched in the forward direction with respect to the current induced by the coil 36.

According to the embodiment of the circuit 34 shown in FIG. 3a, a semiconductor switch 54 in the form of a MOSFET is connected in series with the freewheeling diode 50 for dissipating the energy stored in the coil and for limiting the voltage applied to the control unit connection 42. In this case, the freewheeling diode 50 is connected on the drain side to the semiconductor switch 54 designed in the form of a MOSFET. On the source side, the semiconductor switch 54 is connected to the supply input 46 of the injector 10.

A third resistor 56 is connected in a current path running between the source and the gate of the semiconductor switch 54, to which a second diode 58 is in turn connected in parallel. The second diode 58 has a forward direction from the source to the gate of the semiconductor switch 54. A fourth resistor 60 and a third diode 62 with a forward direction from the gate of the semiconductor switch 54 to the freewheeling diode 50 are connected in a current path running between the gate and the freewheeling diode 50.

According to the alternative embodiment of the circuit 34 shown in FIG. 3b, this also has a Zener diode 52 which is switched in series with the freewheeling diode 50 and directed opposite the freewheeling diode 50 in terms of the forward direction, which Zener diode limits a voltage at the injector and at its control unit connection that is induced by means of the coil 26 after de-energization. Further, the Zener diode 52 serves for the dissipation of the energy stored in the coil.

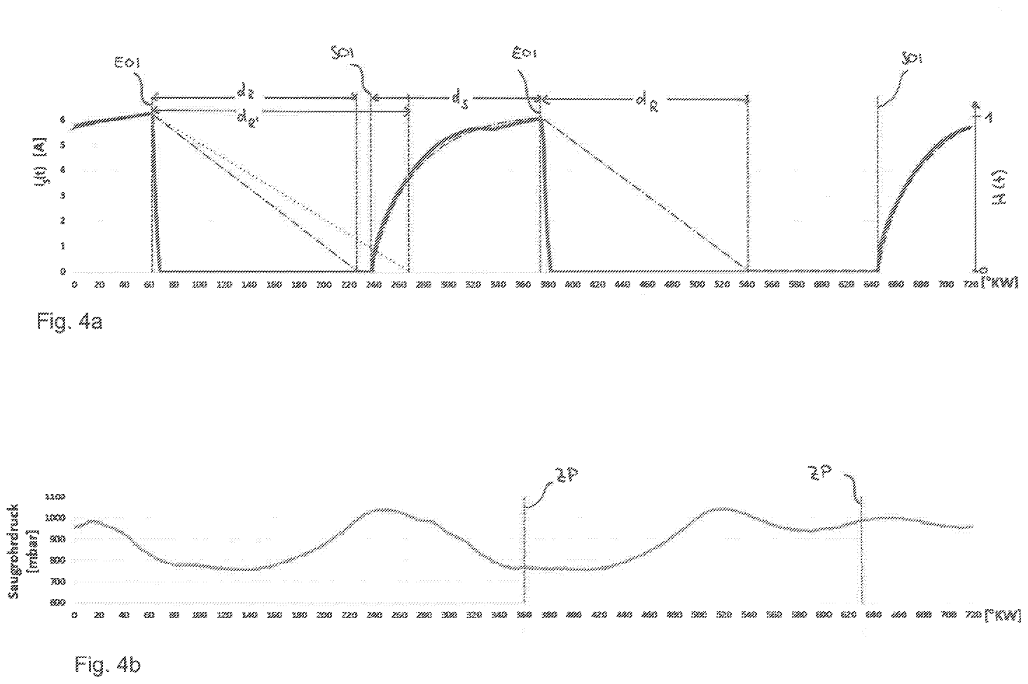

FIG. 4a shows a time profile Iₛ(t) of the current Iₛ through the coil 26. In this case, the crankshaft position per working cycle is indicated in °KW of the crankshaft 14 on the abscissa axis. One working cycle includes 720° KW. For an engine speed, in the present case 3600 revolutions/minute (3600 min⁻¹), this crankshaft position is directly proportional to the time t. The engine speed is expediently specified by means of the first sensor 18 designed as a VR sensor. The engine load here corresponds to an output of 15.5 kW, wherein the engine load is specified by means of the (TMAP sensor) second sensor 22.

FIG. 4b shows a corresponding time profile of the pressure in the air intake also called intake manifold pressure. In an analogous manner to FIG. 4a, the crankshaft position per working cycle is indicated on the abscissa axis.

The internal combustion engine 2 is of a V-type construction. This can be seen in particular in that an intake phase of the first of the two cylinders 4, in which the intake manifold pressure is reduced accordingly, lasts from 0° KW to 180° KW, and the intake phase of the second cylinder 4 from 270° KW to 450° KW. In addition, the ignition timing ZP of the first of the two cylinders 4 is 360° KW and of the second cylinder 4 is 630° KW. The so-called ignition point offset (ignition time offset) is therefore 270° KW.

In particular, due to such a V-type construction of the internal combustion engine 2 and the corresponding time profiles of the intake phases of the cylinders 4, the fuel quantity received in the cylinders 4 would differ despite uniform time intervals of the starting points SOI of the injections, i.e., at a time interval corresponding to 360° KW for the internal combustion engine 2 with two cylinders 4 and a working cycle of 720° KW, as well as despite the same injection quantity EM. As a result, the air-fuel ratios of the two cylinders 4 would also be too rich or too lean.

To avoid this, as shown in FIG. 4a, the starting time SOI, the end time EOI of the injection, and their injection quantity EM based on the temporal current profile Iₛ(t) of the coil 26 of the injector 10 are set in accordance with the present engine load and the present engine speed. The starting time SOI of the injection is the point in time at which the coil 26 is energized in order to bring about the stroke movement of the plunger 24. The end time point EOI of injection is the point in time at which the coil 26 is no longer energized, and consequently the stroke motion of the plunger 24 toward the injection nozzle 28 has ended. The injection quantity EM is set using the time interval from the starting time SOI to the end time EOI of the injection.

For the first cylinder 4, the starting time SOI of the injection is at 645° KW, the end point EOI of the injection is at 60° KW. For the second cylinder 4, the starting time SOI of the injection is at 240° KW and the end time EOI of the injection is at 375° KW.

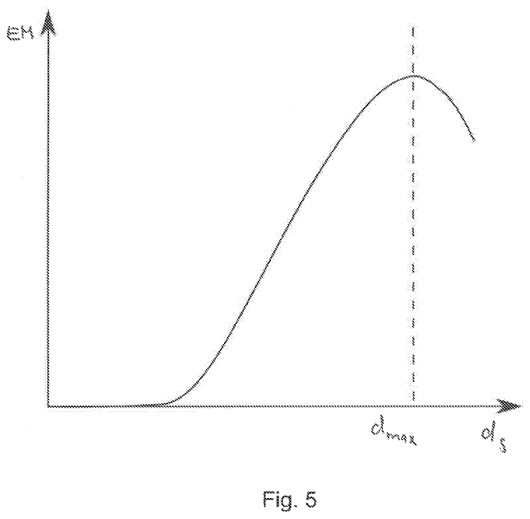

The end time EOI of the injection is specified. The starting time SOI of the injection is specified by means of the injection quantity EM. For this purpose, the relationship shown in FIG. 5 between the injection quantity and the injection duration dₛ, that is to say the time period between the end time EOI of the injection and its starting time SOI, is used. The injection quantity here is 26 mg of fuel per cylinder 4 per working cycle, which according to FIG. 5 corresponds to an injection duration dₛ of 6.3 ms.

FIG. 4a also shows a schematic view of the time profile H(t) of the stroke position H of the plunger 24 as a dash-dotted line. Here, a stroke position H of zero (H=0) corresponds to the starting position and one (H=1) corresponds to the maximum stroke position. The slope of the current profile Iₛ(t) is increased by means of the circuit 34 in one of the variants of FIG. 3a or 3b, and the plunger return time d_{R} is reduced accordingly. In comparison to this, the time profile of the stroke position of the plunger 24 after de-energization of the coil 26 for the injection for the first cylinder 4 until the return to the starting position of the plunger 24 is shown as a dotted line for the event that no circuit 34 is connected in parallel to the injector 10. The plunger return time d_{R} corresponding thereto is greater than the plunger return time d_{R} when the circuit 34 is used. Thus, the plunger 24 has returned to its starting position more quickly with the use of the circuit 34.

During operation, the plunger 24 is preferably moved back to its starting position after the stroke movement. Thus, with the use of the circuit 34, it is possible to set the starting time SOI of the injection closer to the end time EOI of the previous injection. According to the embodiment of FIG. 4a, the starting point SOI of the injection takes place prior to reaching the starting position (H=0) of the plunger 24 when the circuit 34 is not used, which is shown accordingly by the dotted line.

In summary, the starting time SOI of the injection and the end time EOI or the injection quantity EM thereof are set as a function of a plunger return time d_{R} of the plunger 24.

To summarize further, the injection quantity EM of the fuel and the starting time SOI of the injection is specified for each of the cylinders 4 as a function of the present engine load and the present engine speed on the basis of relationships stored in the control unit 20. Subsequently, the injection quantity EM of the fuel and the starting time SOI are set accordingly.

According to a variant not shown, the injection quantities EM of the cylinders 4 are set such that they are different. Here, the energization duration dₛ of the coil 26, i.e., the duration from the starting time SOI of the injection until the end time EOI of the injection, is set according to the relationship shown in FIG. 5.

FIG. 5 shows a diagram which illustrates the relationship of the injection quantity EM and the duration of energization dₛ of the coil 26 for generating the stroke movement of the plunger 24. Here, the injection quantity EM increases steadily with an increasing energization period up to a time period dₘₐₓ and then drops again. This pattern is based on the fact that from the energization period dₘₐₓ, the plunger 24 does not have enough time within the time period specified by the engine speed to be returned to its starting position after de-energization of the coil 26 before the coil 26 is energized again for the subsequent stroke movement. Accordingly, the following stroke movement cannot be performed with the maximum possible stroke distance and correspondingly, less fuel is delivered. This relationship is stored on the control unit 20.

The invention is not limited to the exemplary embodiments described above. Rather, other variants of the invention can also be derived therefrom by a person skilled in the art without departing from the subject matter of the invention. In particular, all of the individual features described in connection with the exemplary embodiments can also be combined with one another in other ways without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an internal combustion engine, the method comprising:
providing at least two cylinders and a single injector for central point injection of fuel into an air intake connected to the cylinders; and
specifying for each of the at least cylinders, an injection quantity of the fuel and a starting time of the injection and set as a function of the present engine load and/or the present engine speed.

2. The method according to claim 1, wherein an end time of the injection is specified and by means of its injection quantity, a starting time is specified.

3. The method according to claim 1, wherein the injector is a unit injector with a coil for moving a plunger, which upon a stroke movement conveys fuel to an injection nozzle, and wherein the starting time of the injection, an end time and/or an injection quantity are set on the basis of a temporal current profile of the coil of the injector.

4. The method according to claim 3, wherein the starting time of the injection, the end time and/or the injection quantity are set as a function of a plunger return time of the plunger.

5. The method according to claim 4, wherein the plunger return time is reduced by increasing the slope of the current profile of the current induced via the coil after de-energization effecting the stroke movement.

6. An internal combustion engine comprising:
at least two cylinders;
a single injector for central point injection of fuel into an air intake that is connected to the at least two cylinders; and
a control unit for carrying out the method according to claim 1.

7. The internal combustion engine according to claim 6, wherein the injector is a unit injector with a plunger that conveys the fuel to an injection nozzle during a stroke movement, and with a coil that in an energized state causes the stroke movement of the plunger towards the injection nozzle.

8. The internal combustion engine according to claim 7, further comprising a circuit connected in parallel with the injector for increasing the slope of the current profile of the current induced via the coil after de-energization of the coil, and for limiting a voltage at a control unit connection of the injector.

9. The internal combustion engine according to claim 8, wherein the circuit has a freewheeling diode and a Zener diode that is connected in series and in an opposite direction, or a semiconductor switch connected in series to a diode for the dissipation of the energy stored in the coil.

10. The internal combustion engine according to claim 6, further comprising a sensor connected to the control unit to determine a position of a crankshaft and/or an engine speed based on a magnet wheel coupled to the crankshaft.
